(19) United States
(12) Patent Application Publication
(10) Pub. No.: US 2023/0118829 A1
(43) Pub. Date: Apr. 20, 2023

(54) METHOD AND APPARATUS FOR EXECUTING DEEP LEARNING PROGRAMS

(71) Applicant: Seoul National University R&DB Foundation, SEOUL (KR)

(72) Inventors: Tae Bum KIM, Seoul (KR); Byung Gon CHUN, Seoul (KR); Geon Woo KIM, Seoul (KR); Yun Mo KOO, Seoul (KR); Gyeong In YU, Seoul (KR); Eun Ji JEONG, Seoul (KR); Se Hoon KIM, Seoul (KR)

(73) Assignee: Seoul National University R&DB Foundation, SEOUL (KR)

(21) Appl. No.: 17/954,345

(22) Filed: Sep. 28, 2022

(30) Foreign Application Priority Data
Oct. 14, 2021 (KR) 10-2021-0136296
Sep. 28, 2022 (KR) 10-2022-0123200

(51) Int. Cl. G06N 3/04; G06F 8/41

(52) U.S. Cl. CPC G06N 3/04; G06F 8/447

(57) ABSTRACT

Disclosed is a method of executing deep learning programs. The method includes generating a symbolic graph corresponding to an imperative deep learning program, dividing the imperative deep learning program into a first portion related to a deep learning computation and a second portion not related to the deep learning computation, and performing a computation on the first portion using a graph runner and simultaneously performing a computation on the second portion using a language runner.

### TECHNICAL FIELD

The following embodiments relate to a method and apparatus for executing deep learning programs, and more specifically, to a method for imperative-symbolic co-execution of deep learning programs.

### BACKGROUND ART

With the development of artificial intelligence (AI) technology, there is an increasing need for independent hardware dedicated to AI. For example, AI may perform inference and learning through predetermined operations. As such, various devices have been developed as exclusive hardware for implementing and executing AI.

The exclusive hardware for AI may be implemented by, for example, a central processing unit (CPU), a graphics processing unit (GPU), or implemented by a field-programmable gate array (FPGA), and an application-specific integrated circuit (ASIC) of changeable use.

The above description is information the inventor(s) acquired during the course of conceiving the present disclosure, or already possessed at the time, and is not necessarily art publicly known before the present application was filed.

### SUMMARY

### Technical Solutions

According to an embodiment, there is provided a method of executing an imperative deep learning program, the method including generating a symbolic graph corresponding to an imperative deep learning program; dividing the imperative deep learning program into a first portion related to a deep learning computation and a second portion not related to the deep learning computation; and performing a computation on the first portion using a graph runner and simultaneously performing a computation on the second portion using a language runner.

The generating of the symbolic graph may further include iterating an imperative execution for the imperative deep learning program; and collecting a plurality of traces corresponding to each iteration of the imperative execution.

The generating of the symbolic graph may further include generating a trace graph corresponding to the collected traces using a graph generator; and generating the symbolic graph based on the trace graph using the graph generator.

The generating of the trace graph may include determining whether there exists an equal node between the collected traces; and merging the collected traces based on a result of the determining.

The generating of the symbolic graph may further include generating one or more communication points for communication between the graph runner and the language runner.

The generating of the symbolic graph may include annotating a communication point including a feed point and a fetch point to a trace graph; generating a feeding operation based on the feed point; and generating a fetching operation based on the fetch point.

The performing of the computation may include delivering, by the language runner, an external tensor to the graph runner based on the feeding operation.

The performing of the computation may include retrieving, by the graph runner, a tensor materialized by the graph runner to the language runner based on the fetching operation.

The method may further include determining whether there is a trace not processible by the symbolic graph; and updating the symbolic graph based on a determination that there is a trace not processible by the symbolic graph.

According to an embodiment, there is provided an electronic device including a memory configured to store at least one instruction; and a processor configured to by executing the instruction stored in the memory, generate a symbolic graph corresponding to an imperative deep learning program, divide the imperative deep learning program into a first portion related to a deep learning computation and a second portion not related to the deep learning computation, and perform a computation on the first portion using a graph runner and simultaneously perform a computation on the second portion using a language runner.

The processor may be configured to iterate an imperative execution for the imperative deep learning program, and collect a plurality of traces corresponding to each iteration of the imperative execution.

The processor may be configured to generate a trace graph corresponding to the collected traces using a graph generator, and generate the symbolic graph based on the trace graph using the graph generator.

The processor may be configured to determine whether there exists an equal node between the collected traces, and merge the collected traces based on a result of the determining.

The processor may be configured to generate one or more communication points for communication between the graph runner and the language runner.

The processor may be configured to annotate a communication point including a feed point and a fetch point to a trace graph, generate a feeding operation based on the feed point, and generate a fetching operation based on the fetch point.

The processor may be configured to cause the language runner to deliver an external tensor to the graph runner based on the feeding operation.

The processor may be configured to cause the graph runner to retrieve a tensor materialized by the graph runner to the language runner based on the fetching operation.

The processor may be configured to determine whether there is a trace not processible by the symbolic graph, and update the symbolic graph based on a determination that there is a trace not processible by the symbolic graph.

### BRIEF DESCRIPTION OF THE DRAWINGS

FIG. 1 is a diagram illustrating a method for deep learning computation using an artificial neural network.

FIG. 2 is a diagram illustrating a method for imperative-symbolic co-execution of a deep learning program according to an embodiment.

FIG. 3A is a diagram illustrating a method of collecting traces and generating a trace graph according to an embodiment.

FIG. 3B is a diagram illustrating a method of applying a just-in-time (JIT) compilation to track a call ID and a loop ID according to an embodiment.

FIG. 3C is a diagram illustrating an example of occurrence of a deadlock according to an embodiment.

FIG. 4A is a diagram illustrating a method of generating a symbolic graph according to an embodiment.

FIG. 4B is a diagram illustrating an example of receiving a trace graph and outputting an ordered list of switch-cases according to an embodiment.

FIG. 4C is a diagram illustrating a case assignment algorithm according to an embodiment, and 4D is a diagram illustrating an example of applying a case assignment algorithm according to an embodiment.

FIG. 5 is a diagram illustrating a configuration of an electronic device according to an embodiment.

### DETAILED DESCRIPTION

The following structural or functional descriptions disclosed in the present disclosure are merely intended for the purpose of describing the embodiments and the embodiments may be implemented in various forms. The embodiments are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The embodiments may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. In the drawings, like reference numerals are used for like elements.

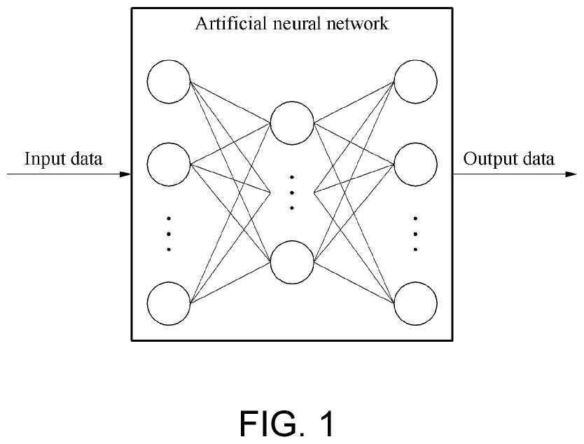

FIG. 1 is a diagram illustrating a method for deep learning computation using an artificial neural network.

An artificial intelligence (AI) algorithm including deep learning may input data into an artificial neural network (ANN), train the ANN with output data through operations such as convolution, and extract features using the trained ANN. The ANN may be a computational architecture that models a biological brain. In the ANN, nodes corresponding to neurons in the brain are connected to each other and collectively operate to process the input data. Various types of neural networks may include, for example, a convolutional neural network (CNN), a recurrent neural network (RNN), a deep belief network (DBN), or a restricted Boltzmann machine (RBM), but is not limited thereto. In a feed-forward neural network, neurons may have links to other neurons. The links may be expanded in a single direction, for example, a forward direction, through a neural network.

FIG. 1 illustrates a structure of an ANN (e.g., a convolutional neural network (CNN)) for receiving input data and outputting output data. The ANN may be a deep neural network (DNN) including at least two layers.

Deep learning frameworks may provide users with a programming layer to build and execute ANN models. For example, the deep learning frameworks may provide users with a programming layer to build and execute ANN models, adopting Python as their host language.

Typically, the deep learning frameworks may execute deep learning programs with one of two execution models: imperative or symbolic execution.

For example, in the imperative execution, a Python interpreter may execute a deep learning program as a normal program, invoking deep learning (DL) operations on-the-fly. The invoked DL operations may be executed on a separate DL accelerator asynchronously, and the Python interpreter may continue running the program. The dynamic control flows of the DL operations may be naturally expressed by the interpretation of the program, and users may utilize any functionalities (e.g., dynamic typing and third-party libraries) of the programming language (e.g., Python) while executing DL operations.

In the symbolic execution model, the Python interpreter may embed DL operations into a symbolic graph that represents the entire dataflow of an ANN model. Thus, users should define their DL programs only with existing symbolic operations that DL frameworks support. In other words, the dynamic control flows of an ANN model should be explicitly represented by control flow operations (e.g., tf.cond and tf.while of TensorFlow). The symbolic execution may take advantages of various optimization techniques because the symbolic graph contains a whole computation lineage of an ANN model architecture.

Although a symbolic execution model achieves higher performance compared to an imperative execution model, the imperative execution model has been preferred because of its usability. Accordingly, several systems have been proposed to match the speed of the symbolic execution model while enjoying the benefit of the imperative execution model.

These systems may generate a symbolic graph that represents an entire imperative program and execute the graph instead of imperatively running the program. Methods of generating the symbolic graph may be broadly classified into two approaches: single path tracing and static compilation. Systems that adopt single path tracing may generate a symbolic graph by imperatively executing a single iteration of a program and recording the executed ANN model operations. Systems that adopt static compilation may translate the abstract syntax tree (AST) of a program into a symbolic graph.

However, both approaches may correctly handle only a subset of imperative DL programs. For example, dynamic control flows in an imperative program may not be captured by the single path tracing approach. Further, the static compilation approach may not correctly generate a symbolic graph if a target program contains an AST node that does not have a corresponding symbolic operation such as try-excepts, generators, Python object mutations, and third-party library calls.

As described below, while the previous approaches may replace the imperative execution with the symbolic execution, a method for imperative-symbolic co-execution of a deep learning program according to an embodiment may maintain the imperative execution to support all language (e.g., Python) features where DL operations are delegated to the symbolic execution.

The method for imperative-symbolic co-execution of a deep learning program according to an embodiment may generate a symbolic graph corresponding to an imperative deep learning program, divide the imperative deep learning program into a first portion related to a deep learning computation and a second portion (e.g., a Python language features portion) other than the first portion, and perform a computation on the first portion using a graph runner and simultaneously perform a computation on the second portion using a language runner. Therefore, the method for imperative-symbolic co-execution of a deep learning program according to an embodiment may run any imperative DL programs correctly and efficiently even if it contains the Python features that the previous approaches may not handle.

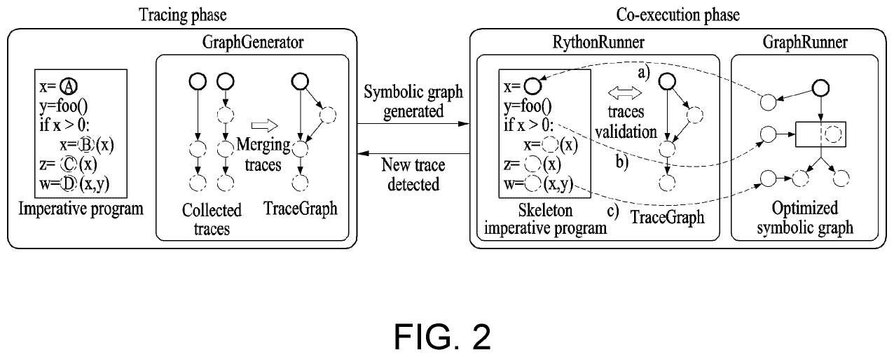

FIG. 2 is a diagram illustrating a method for imperative-symbolic co-execution of a deep learning program according to an embodiment.

Referring to FIG. 2, a method for imperative-symbolic co-execution of a deep learning program (hereinafter, referred to as the co-execution method for ease of description) according to an embodiment may include a tracing phase and a co-execution phase. The co-execution method according to an embodiment may be performed by a co-execution system, and the system may also be referred to as “Terra”.

The tracing phase according to an embodiment may include collecting a plurality of traces, generating a trace graph corresponding to the collected traces, and generating a symbolic graph based on the generated trace graph.

More specifically, in the tracing phase according to an embodiment, an imperative execution for an imperative deep learning program may be iterated. At the same time, a graph generator according to an embodiment may collect a plurality of traces corresponding to each iteration of the imperative execution.

The graph generator according to an embodiment may generate a trace graph by merging all the collected traces. The trace graph according to an embodiment may be a directed acyclic graph (DAG) that encapsulates all the collected traces.

Since it is impossible to determine the number of possible traces during the imperative execution, the graph generator according to an embodiment may collect traces until the trace of the latest iteration is fully covered in the trace graph. The graph generator according to an embodiment may generate a symbolic graph based on the generated trace graph.

In the co-execution phase according to an embodiment, a graph runner and a language runner (e.g., a Python runner) may be used.

The language runner according to an embodiment may execute a skeleton imperative program that does not launch DL operations anymore. At the same time, the graph runner according to an embodiment may perform DL operations using a symbolic graph. For each DL operation, the language runner according to an embodiment may skip the actual computation and generate an empty tensor object(s) as an output(s) of the operation.

In the co-execution phase according to an embodiment, the graph runner and the language runner may exchange necessary data through communication. More specifically, if the language runner according to an embodiment has to materialize an empty tensor (e.g., print a loss value), the language runner may fetch the actual data from the graph runner. Similarly, the graph runner according to an embodiment may need an external tensor (e.g., an input data, a Python primitive value) from the language runner. In this case, the graph runner may fetch the corresponding data from the language runner.

For every iteration in the co-execution phase, the language runner may keep a trace being made by the DL operations in the current iteration. More specifically, the language runner according to an embodiment may continuously compare the trace with the trace graph to notify the graph runner of the current control flow and check the validity of the symbolic graph in the graph runner.

If the latest DL operation in the trace indicates that the language runner takes a specific path, the language runner may inform the graph runner of the path with a new symbolic operation, which sets a conditional input of a corresponding control flow operation in the symbolic graph.

For example, if the language runner takes the true path of the skeleton imperative program (e.g., if x>0), the graph runner may receive such information from the language runner and execute the operation of the true path.

Furthermore, if the latest DL operation is not expressed in the trace graph, the co-execution method according to an embodiment may consider the current trace as a new trace that the existing symbolic graph may not handle. The co-execution method according to an embodiment may then cancel the execution of the graph runner and fall back to the tracing phase. Thereafter, the graph generator may collect more traces and generate a new symbolic graph covering more traces than before to continue the co-execution. Generating a new symbolic graph according to an embodiment may also be referred to as updating the symbolic graph.

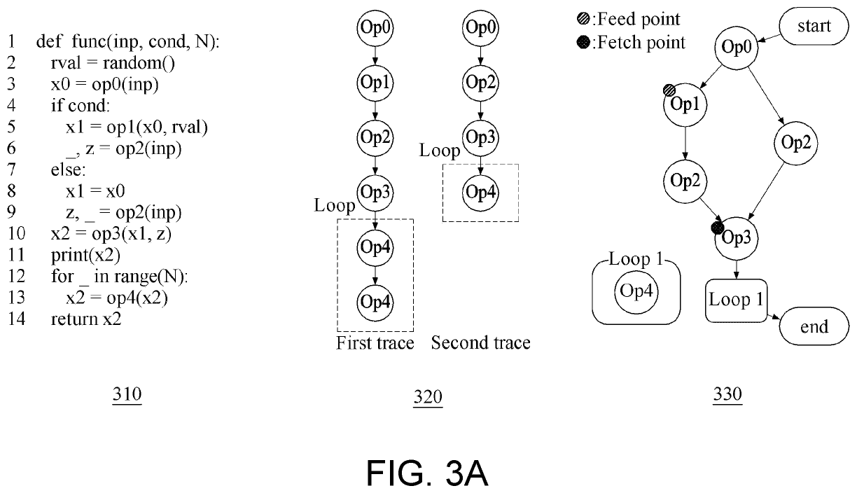

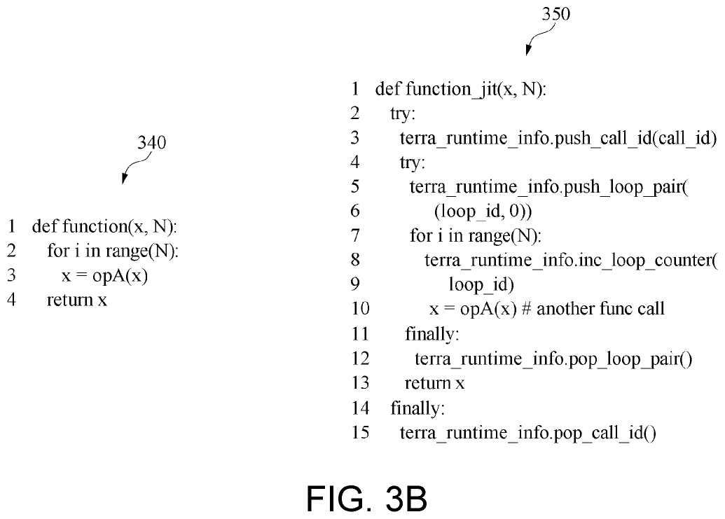

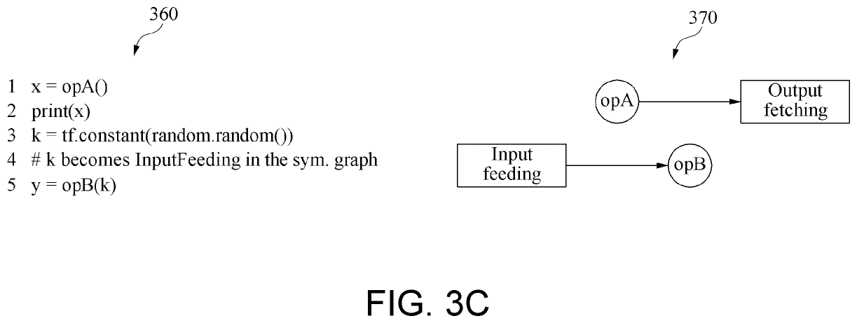

FIG. 3A is a diagram illustrating a method of collecting traces and generating a trace graph according to an embodiment.

Referring to FIG. 3A, a graph generator according to an embodiment may iterate an imperative execution for an imperative deep learning program 310, collect a plurality of traces corresponding to each iteration of the imperative execution, and generate a trace graph 330 corresponding to the collected traces 320.

The trace graph 330 according to an embodiment may include a plurality of nodes and edges connecting the nodes, and each node may correspond to a DL operation, and each edge may denote an execution order between two nodes.

The graph generator according to an embodiment may determine whether there exists an equal node between the collected traces, and merge the collected traces based on a result of the determining. Whether there exists an equal node according to an embodiment may be determined based on the type of operation (e.g., Conv2D and MatMul), attributes of operation (e.g., a filter size and a kernel size), and whether two operations were executed at the same location of the program. A type of an operation according to an embodiment may be a kind of the operation, and attributes of the operation may be information that determines the behavior of the operation. For example, the MatMul operation of TensorFlow may have “MatMul” as its type, and take transpose_a and transpose_b as the operation attributes. Accordingly, the graph generator may determine that the MatMul operation whose transpose_a is true is not the same as the MatMul operation whose transpose_a is false.

An executed location of an operation according to an embodiment may be the program location in which the operation is actually executed. Since the executed location of the operation is determined at runtime, the graph generator according to an embodiment may utilize a just-in-time (JIT) compilation to evaluate the location.

FIG. 3B is a diagram illustrating a method of applying a just-in-time (JIT) compilation to track a call ID and a loop ID according to an embodiment.

Referring to FIG. 3B, an example 340 relates to an original program, and an example 350 relates to a transformed program. A co-execution system according to an embodiment may assign a unique call ID to every function call and a unique loop ID to every loop in a given imperative DL program. For each function call, the call ID of the function may be pushed to the call ID stack, which may accumulate the call IDs. The co-execution system may manage the call ID stack for the entire program execution, including the tracing phase and the co-execution phase. The pushed call ID may be popped when the function is returned. Thus, the call ID stack may contain all information of nested function calls. Similarly, the pair of (loop ID, loop counter=0) of the loop may be pushed to the loop ID stack for each loop. The loop counter may be increased for every new iteration of the loop, and the pair of (loop ID, loop counter) may be generated after exiting the loop. As same as the call ID stack, the co-execution system according to an embodiment may manage the loop ID stack for the entire program execution.

Referring back to FIG. 3A, the graph generator according to an embodiment may collect two traces from the collected traces 320. When the graph generator according to an embodiment attempts to merge the second trace into the trace graph that contains the first trace, Op2 of the second trace may not be matched with Op1 of the first trace and may not be merged back into Op2 of the first trace because two Op2s were executed in different locations. On the other hand, the graph generator may merge Op3 of the second trace into Op3 of the first trace because Op3 of the second trace matches Op3 of the first trace.

Furthermore, the graph generator may merge the nodes that are executed in the same loop of the program. The graph generator may be aware of the loop because it compares the program location where DL operations were executed. The graph generator may then group those nodes within an extra loop node and conduct merging the nodes separately. For example, Loop 1 in the trace graph 330 may be the loop node for the loop corresponding to line 12-13 of the imperative deep learning program 310. The graph generator may merge the second Op4 of the first trace with the first Op4 of the first trace because those operations were executed in the same loop. Also, Op4 of the second trace may be merged to the same node.

To generate symbolic operations for data communication between the language runner and the graph runner, the graph generator according to an embodiment may capture communication points and annotate such points in the trace graph. The communication points according to an embodiment may include feed points and fetch points.

A feed point according to an embodiment may be where the operation gets an input from the Python interpreter such as training data and Python primitive values. A fetch point according to an embodiment may be where the Python interpreter needs a value of the DL tensor.

For example, referring to the imperative deep learning program 310, Op1 may receive rval as an input (line 5), and the Python interpreter may need the value of x2 (line 11) to print it out. Accordingly, the graph generator according to an embodiment may determine a node corresponding to line 5 of the imperative deep learning program 310 to be a feed point a node corresponding to line 11 of the imperative deep learning program 310 to be a fetch point, and annotate each of the nodes.

FIG. 3C is a diagram illustrating an example of occurrence of a deadlock according to an embodiment.

Referring to FIG. 3C, although the language runner according to an embodiment may execute the skeleton imperative program sequentially, the graph runner may allow out-of-order execution. Thus, a deadlock may occur if the language runner and the graph runner conduct the co-execution.

For example, it may be assumed that the language runner executes an imperative program shown in an example 360 and the graph runner according to an embodiment conducts a symbolic graph computation as shown in an example 370. Since the two operations according to an embodiment do not have data and control dependency in the symbolic graph (i.e., opB does not consume the output of opA), the graph runner may freely select the execution order between the operations.

If the graph runner according to an embodiment executes opB then opA, the deadlock may occur because the language runner should receive the output of opA to print its value before the language runner feeds the value k to opB in the graph runner.

To prevent the deadlock, the graph generator according to an embodiment may add the control dependencies (e.g., defined in TensorFlow) between output fetching operations that should be executed prior to and an input feeding operation after generating a symbolic graph.

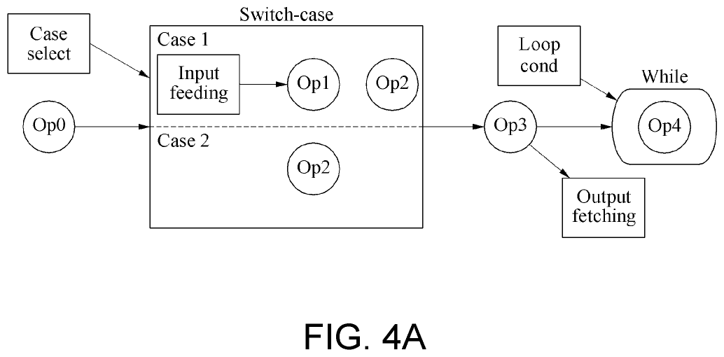

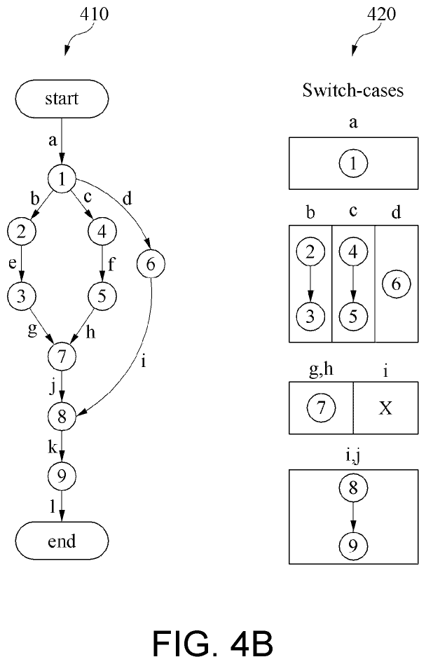

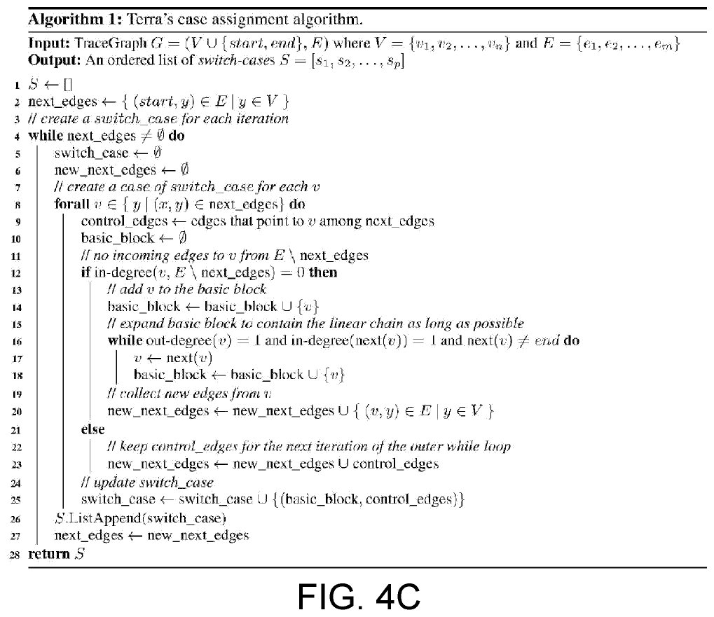

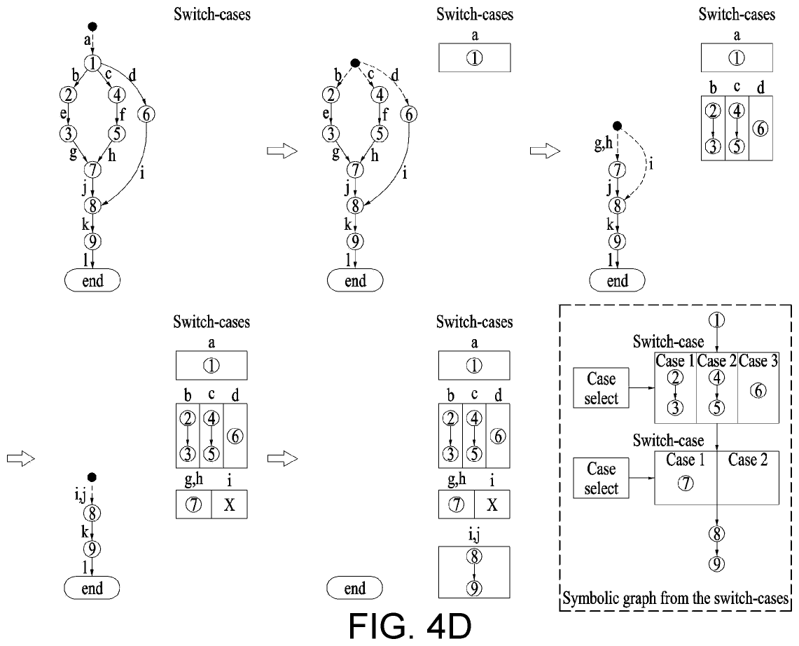

FIG. 4A is a diagram illustrating a method of generating a symbolic graph according to an embodiment.

A graph generator according to an embodiment may convert nodes in a trace graph to corresponding DL operations and generate additional input feeding and output fetching operations to establish data communication during co-execution.

The input feeding operation according to an embodiment may correspond to a feed point of the trace graph, enabling a language runner to feed an external tensor to the graph runner.

The fetching operation according to an embodiment may correspond to a fetch point of the trace graph, allowing the language runner to fetch a materialized DL tensor from the graph runner.

The graph generator may represent the entire computation lineage in the single graph with the communication operations. Without those operations, the graph generator may split the symbolic graph into smaller subgraphs at every feed-fetch point and miss potential optimization opportunities.

To handle the diverse control flows in the trace graph, the graph generator may utilize the Switch-Case operation (e.g., tf.case of TensorFlow), which allows executing only a single case that depends on a particular condition.

FIG. 4B is a diagram illustrating an example of receiving a trace graph and outputting an ordered list of switch-cases according to an embodiment.

A co-execution system according to an embodiment may take a trace graph as an input and return an ordered list of switch-cases. A switch-case according to an embodiment may be a set of (basic block, control edges) where the basic block may be a linear chain of nodes, and the control edges may be the edges that point to the basic block.

Every non-overlapping linear chain of nodes in the trace graph according to an embodiment may be uniquely assigned to a basic block so that the ordered list of switch-cases may cover every trace in the trace graph. If there is a loop node in the trace graph, the algorithm may treat the loop node as a single node because the loop node is converted to a While operation in the symbolic graph. For example, the co-execution system according to an embodiment of FIG. 4B may take a trace graph 410 and return an ordered list of switch-cases 420.

For the conditional input that informs the switch-case operation, the graph generator may generate a case select operation along with the switch-case operation. When the language runner takes a certain path, it may notify the graph runner via the case select operation. Here, the graph generator may use a case assignment algorithm that takes the trace graph as an input, traverses the trace graph, and returns the switch-case operations representing the control flows correctly.

FIG. 4C is a diagram illustrating a case assignment algorithm according to an embodiment, and 4D is a diagram illustrating an example of applying a case assignment algorithm according to an embodiment.

The case assignment algorithm according to an embodiment may traverse the given trace graph in topological order and make each basic block contain a linear chain of nodes as long as possible.

In FIG. 4C, “G” denotes a trace graph composed of nodes including a start node and an end node and edges, “V” denotes a node set including v₁ to vₙ as its elements, and “E” denotes an edge set including e₁ to eₘ as its elements. The start node according to an embodiment may be a unique source node whose in-degree is “0”, and the end node according to an embodiment may be a unique sink node whose out-degree is “0”.

A linear chain set of nodes according to an embodiment “L” may be {v₁; . . . , v₁}⊆V such that for all 2≤i≤1, (vᵢ₋₁, vᵢ)∈E, the in-degrees of all nodes are “1” (except v₁), and the out-degrees of all nodes are “1” (except v₁). Also, a linear chain set of edges I(L) may be a set that satisfies {(vᵢ₋₁, vᵢ)|2≤i≤1}.

A case c according to an embodiment may be a pair of (basic block L_{c}, control edges E_{c}) where the basic block may be a linear chain set of nodes, and the control edges may be edges that point to the basic block. A switch-case s according to an embodiment may be a set of cases that satisfies the following Equation 1.

∀c₁,c₂∈s such that c₁≠c₂, L_{c}_{₁}∩L_{c}_{₂}=∅ and E_{c}_{₁}∩E_{c}_{₂}=∅ [Equation 1]

A trace t according to an embodiment may be (Vt∪{start, end}, Et) that satisfies the following Equation 2.

[Equation 2]

Vₜ={v₁, . . . , vₖ₋₁}⊆V and Eₜ={e₁, . . . , eₖ}⊆E 1.

∀1≤i≤k, eᵢ=(vᵢ₋₁,vᵢ) where v₀=start, vₖ=end 2.

The operation nodes Op(t) of the trace t according to an embodiment may be Vₜ, and the path Path(t) of the trace t may be Eₜ.

An ordered list S of switch-cases according to an embodiment may include S₁ to Sₚ as its elements, and each switch-case may cover a trace t if conditions according to an embodiment hold.

The conditions according to an embodiment may include 1) Condition 1 that for all sᵢ, there exists a unique case cᵢ=(L_{ci}, E_{ci})∈sᵢ with a unique edge dᵢ such that {dᵢ}=E_{ci} ∩Path(t) is satisfied, and 2) Condition 2 that the operations in the trace are represented as the linear chains of cᵢ, and all edges in the trace are the union of in-chain edges dᵢ and eₖ. The conditions may be expressed by the following Equation 3.

$$Op ( t ) = {{⋃}_{i = 1}}^{p} {L}_{{c}_{i}} and Path ( t ) = [ {{⋃}_{i = 1}}^{p} ( \{ {d}_{i} \} ⋃ I ( {L}_{{c}_{i}} ) ) ] ⋃ \{ {e}_{k} \} \qquad [ Equation 3 ]$$

A graph Gₛ=(Vₛ ∪{start, end}, Eₛ) according to an embodiment may be a sub-trace graph if the following Equation 4 is satisfied.

[Equation 4]

Gₛ is a TraceGraph and Vₛ⊆V. 1.

Eₛ=E₁∪E₂ where 2.

E₁={(u,v)∈E|u∈Vₛ∪{start},v∈Vₛ∪{end}}

E₂={(u,end)|(u,v)∈E, u∈Vₛ∪{start},v≠Vₛ∪{end}}.

Referring to FIGS. 4C and 4D, according to the case assignment algorithm according to an embodiment, “next_edges” may be initialized with {edge a} at line 2, and the in-degree of node 1 may be calculated from “E\ next_edges” at line 12. Since node 1 has no more incoming edge except for edge a, node 1 may become the first node of the basic block at line 14.

Then, the case assignment algorithm according to an embodiment may attempt to expand the basic block as long as possible, but the basic block may not expand because the out-degree of node 1 is 3 so that node 1 is the end of the linear chain (see line 16). Thus, the first switch-case may become ({node 1}, {edge a}) at line 25.

At the next iteration, the next edges may become {edge b, edge c, edge d}, and three basic blocks may be generated in the single switch-case. Two of the basic blocks may contain the linear chain with two nodes, {node 2, node 3} and {node 4, node 5}, and the last basic block may contain {node 6}.

When the case assignment algorithm according to an embodiment processes edge i along with {edge g, edge h}, the case assignment algorithm may not put node 8 into the basic block because the in-degree of node 8 is not zero (see line 12) due to edge j. Thus, the basic block may become an empty set. The case assignment algorithm according to an embodiment may return the ordered list of switch-cases after generating the basic block with node 8 and node 9.

Each switch-case within the result of the case assignment algorithm according to an embodiment may become the switch-case operation in the symbolic graph. If a switch-case contains only a single basic block, the graph generator may not generate a redundant switch-case operation.

For each switch-case operation, the graph generator according to an embodiment may generate the case select operation. During the co-execution phase, the language runner may inform the graph runner of the control edge taken via the case select operation. For example, if the language runner follows edge c of FIG. 4C, the graph runner may execute “Operation 2” of the first switch-case operation.

Referring back to FIG. 4A, the graph generator may generate the while operation (e.g., tf.while of TensorFlow) for a loop node of the trace graph. As the case select operation, the graph generator may generate the Loop Cond operation along with the while operation.

The language runner according to an embodiment may inform the graph runner of whether the language runner goes to the next iteration of the loop or exits the loop via the Loop Cond operation. The graph generator may unroll the while operation if the loop node took the same number of iterations in the collected traces.

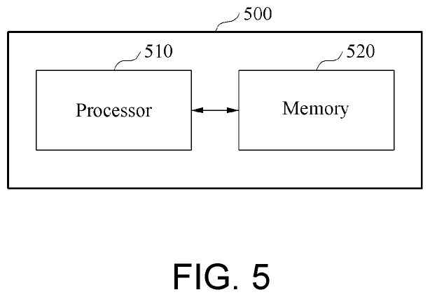

FIG. 5 is a diagram illustrating a configuration of an electronic device according to an embodiment.

Referring to FIG. 5, an electronic device 500 according to an embodiment may include at least one processor 510 and a memory 520.

The memory 520 according to an embodiment may store computer-readable instructions. When the instructions stored in the memory 520 are executed by the processor 510, the processor 510 may process operations defined by the instructions. The memory 520 may include, for example, random-access memory (RAM), dynamic random-access memory (DRAM), static random-access memory (SRAM), or other types of non-volatile memory known in the art. The memory 520 may store a pretrained ANN-based generative model.

The at least one processor 510 according to an embodiment may control the overall operation of the electronic device 500. The processor 510 may be a hardware-implemented apparatus having a circuit that is physically structured to execute desired operations. The desired operations may include code or instructions included in a program. The hardware-implemented apparatus may include, but is not limited to, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The processor 510 according to an embodiment may control the electronic device 500 by executing functions and instructions for execution in the electronic device 500. The processor 510 may control the electronic device 500 to perform the at least one operation and/or function described above with reference to FIGS. 2 to 4.

By the control of the processor 510 according to an embodiment, the electronic device 500 may generate a symbolic graph corresponding to an imperative deep learning program, divide the imperative deep learning program into a first portion related to a deep learning computation and a second portion not related to the deep learning computation, and performing a computation on the first portion using a graph runner and simultaneously performing a computation on the second portion using a language runner.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A method of executing an imperative deep learning program, the method comprising:
generating a symbolic graph corresponding to an imperative deep learning program;
dividing the imperative deep learning program into a first portion related to a deep learning computation and a second portion not related to the deep learning computation; and
performing a computation on the first portion using a graph runner and simultaneously performing a computation on the second portion using a language runner.

2. The method of claim 1, wherein
the generating of the symbolic graph further comprises:
iterating an imperative execution for the imperative deep learning program; and
collecting a plurality of traces corresponding to each iteration of the imperative execution.

3. The method of claim 2, wherein
the generating of the symbolic graph further comprises:
generating a trace graph corresponding to the collected traces using a graph generator; and
generating the symbolic graph based on the trace graph using the graph generator.

4. The method of claim 3, wherein
the generating of the trace graph comprises:
determining whether there exists an equal node between the collected traces; and
merging the collected traces based on a result of the determining.

5. The method of claim 1, wherein
the generating of the symbolic graph further comprises:
generating one or more communication points for communication between the graph runner and the language runner.

6. The method of claim 1, wherein
the generating of the symbolic graph comprises:
annotating a communication point comprising a feed point and a fetch point to a trace graph;
generating a feeding operation based on the feed point; and
generating a fetching operation based on the fetch point.

7. The method of claim 6, wherein
the performing of the computation comprises:
delivering, by the language runner, an external tensor to the graph runner based on the feeding operation.

8. The method of claim 6, wherein
the performing of the computation comprises:
retrieving, by the graph runner, a tensor materialized by the graph runner to the language runner based on the fetching operation.

9. The method of claim 1, further comprising:
determining whether there is a trace not processible by the symbolic graph; and
updating the symbolic graph based on a determination that there is a trace not processible by the symbolic graph.

10. A non-transitory computer-readable storage medium storing instructions that, when executed by a processor, cause the processor to perform the method of claim 1.

11. An electronic device, comprising:
a memory configured to store at least one instruction; and
a processor configured to:
by executing the instruction stored in the memory,
generate a symbolic graph corresponding to an imperative deep learning program,
divide the imperative deep learning program into a first portion related to a deep learning computation and a second portion not related to the deep learning computation, and
perform a computation on the first portion using a graph runner and simultaneously perform a computation on the second portion using a language runner.

12. The electronic device of claim 11, wherein
the processor is configured to:
iterate an imperative execution for the imperative deep learning program, and
collect a plurality of traces corresponding to each iteration of the imperative execution.

13. The electronic device of claim 12, wherein
the processor is configured to:
generate a trace graph corresponding to the collected traces using a graph generator, and
generate the symbolic graph based on the trace graph using the graph generator.

14. The electronic device of claim 13, wherein
the processor is configured to:
determine whether there exists an equal node between the collected traces, and
merge the collected traces based on a result of the determining.

15. The electronic device of claim 14, wherein
the processor is configured to:
generate one or more communication points for communication between the graph runner and the language runner.

16. The electronic device of claim 11, wherein
the processor is configured to:
annotate a communication point comprising a feed point and a fetch point to a trace graph,
generate a feeding operation based on the feed point, and
generate a fetching operation based on the fetch point.

17. The electronic device of claim 16, wherein
the processor is configured to:
cause the language runner to deliver an external tensor to the graph runner based on the feeding operation.

18. The electronic device of claim 16, wherein
the processor is configured to:
cause the graph runner to retrieve a materialized tensor by the graph runner to the language runner based on the fetching operation.

19. The electronic device of claim 11, wherein
the processor is configured to:
determine whether there is a trace not processible by the symbolic graph, and
update the symbolic graph based on a determination that there is a trace not processible by the symbolic graph.
